(19) United States
(12) Patent Application Publication
(10) Pub. No.: US 2003/0011247 A1
(43) Pub. Date: Jan. 16, 2003

(54) Power supply device

(75) Inventors: Jun Kajiwara, Kyoto (JP); Masayoshi Kinoshita, Osaka (JP); Shiro Sakiyama, Kyoto (JP)

Correspondence Address: Jack Q. Lever, Jr., McDERMOTT, WILL & EMERY, 600 Thirteenth Street, N.W., Washington, DC, 20005-3096, US

(73) Assignee: Matsushita Electric Industrial Co., Ltd.

(21) Appl. No.: 10/195,758

(22) Filed: Jul. 16, 2002

(30) Foreign Application Priority Data
Jul. 16, 2001 (JP) 2001-214718

(51) Int. Cl. H02H 1/00

(52) U.S. Cl. 307/125

(57) ABSTRACT

A power supply device is provided in which, in order to increase a rise speed of an output voltage and to suppress a voltage drop when switching between power supply devices, during a second operation mode in which power supply is stopped, an output switch is turned off and a reference voltage generating circuit applies a reference voltage Vref2, which equals a gate voltage in a steady state during power supply (first operation mode), to the gate of an output transistor. Thus, when entering the first operation mode, the feedback operation of a differential operational amplifier quickly reaches a steady state. In addition, during the second operation mode, a switch that supplies power to the reference voltage generating circuit and the differential operational amplifier is open, reducing the power consumption of the power supply device itself.

### BACKGROUND OF THE INVENTION

1. Field of the Invention

The present invention relates to a technology pertaining to a power supply device that supplies electric power to circuits in LSIs or in various apparatus at a predetermined controlled voltage, such as a stabilized voltage or a second voltage that is obtained by converting a first voltage.

2. Description of the Related Art

In recent years, portable electronic equipment such as mobile telephones and notebook personal computers has been coming into widespread use. One of the keys for the portable electronic equipment to attain widespread use is an improvement in battery operating time, in which devices can operate with batteries. Thus, reducing power consumption of LSIs or the like in the equipment is an important issue in the art.

An example of a technique used to reduce power consumption is as follows. In the field of LSIs used in mobile telephones, for example, such a technique is used in which an LSI itself has two or more operation states; specifically, for example, during talk time, the LSI is operated in an active state, whereas during standby time, it is operated in a standby state, in which only retention of information is possible. For power supply devices, such a configuration as follows is employed at times. During the standby state, in order to reduce the power consumption of the power supply device itself, a power supply device is operated in a low power supply state, in which power supply is small and power consumption is low, whereas during the active state, it enters a normal power supply state, in which a large power can be supplied.

An example of the power supply device having two power supply states such as described above is disclosed in Japanese Unexamined Utility Model Publication 61-84923. As shown in FIG. 25, this device has a configuration in which the voltage of a power supply 901 is stepped down by a voltage regulating circuit 902 or a voltage correcting circuit 903 composed of a plurality of diodes to supply the voltage to a load 904. This power supply device is configured so that, when the load current is large, electric power is supplied from the voltage regulating circuit 902, which is selected by a switching circuit 905 in response to a switch controlling signal 906 (normal power supply state). On the other hand, during no load condition or a light load condition in which the load current value is small, a stepped-down voltage is supplied by the voltage correcting circuit 903 (low power supply state). Thus, during a light load condition or no load condition in which the quiescent current consumption in the power supply device itself is noticeable, for example, the power in the voltage regulating circuit 902 is reduced so that the quiescent current 907 becomes negligible, in order to achieve a higher current efficiency over a wide range of load current.

The power supply device disclosed in Japanese Unexamined Patent Publication 11-219586 is also known. In this device, as shown in FIG. 26, a voltage converting circuit 920 is used (low power supply state) when an apparatus that requires electric power is in a standby state whereas a voltage converting circuit 921 is used (normal power supply state) when the device is in an active state. The voltage converting circuit 921 is so configured that when power supply is to be stopped, output transistor switches 921b to 921d are sequentially turned off under the control of a delay circuit 921a to reduce the output current gradually (in a stepwise manner), thus reducing the noise that is generated at the switching between the voltage converting circuits 920 and 921.

These conventional power supply devices, however, have at least the following drawbacks. For example, when the power supply device is switched to the normal power supply state or to the low power supply state, the states of various portions therein, such as a feedback circuit, do not immediately enter a steady state, and therefore, a sufficient current supplying capability cannot be obtained immediately after the switching. Consequently, a temporary voltage drop of the output voltage is caused, which leads to unstable operations in the apparatus or the like in which the power supply device is incorporated. Therefore, when stepwise fluctuations (increase or decrease) in the load current occur, for example, when the apparatus or the like shifts from a standby state to an active state, it is difficult for the power supply device to switch between the normal power supply state and the low power supply state so as to respond to the load fluctuations. In addition, even when a power supply device is used as a single unit, (i.e., when the switching between a plurality of power supply states does not occur), the rise of the output voltage is slow at the start of power supply, which is another problem.

For the purpose of, for example, reducing a voltage drop in the output voltage as described above, it may appear to be conceivable to adopt a technique such that response characteristics of the power supply device are increased to attain a steady current supply state quickly, or a technique such that a capacitor having a large capacitance is provided at the output terminal of the power supply device to complement the supply current. However, on the one hand, the technique of increasing response characteristics necessitates a larger quiescent current consumption in the power supply device itself, which considerably reduces current efficiency during the normal power supply state. On the other hand, the technique of employing a capacitor with a large capacitance causes increases in the chip area and chip cost, for example, which make it difficult to integrate the capacitor in the LSI to attain a one-chip device.

### SUMMARY OF THE INVENTION

In view of the foregoing and other problems in the prior art, it is an object to the present invention to provide a power supply device in which the output voltage can rise fast, an output voltage drop can be avoided or reduced at the switching between current supply states or the like, a high current efficiency can be achieved over a wide range of load current without causing a considerable increase in the quiescent current consumption in the power supply device itself, and moreover the device can be easily integrated into a single chip.

In order to accomplish the foregoing and other objects, the present invention provides a power supply device comprising: a controlling means for controlling an output voltage to a predetermined voltage during a first operation mode for supplying power; a cut-off means for cutting off the output voltage during a second operation mode for halting the power supply; a control state-maintaining means for maintaining a state of at least a portion of the controlling means to be in a standby state during the second operation mode, the standby state corresponding to a state of the portion of the controlling means during the first operation mode.

In the above-described power supply device, the standby state may be a state that is closer to the state during the first operation mode than to the state during the second operation mode.

In the above-described power supply device, the standby state may be a state such that the amount of fluctuation of the output voltage is less than a predetermined amount when the operation mode switches from the second operation mode to the first operation mode.

In the above-described power supply device, the controlling means may comprise an output transistor that generates the output voltage according to a voltage of a control terminal; and the control state-maintaining means may be configured so that a voltage of the control terminal is maintained at a predetermined voltage.

In the above-described power supply device, the controlling means may comprise an output transistor that generates the output voltage according to a current of a control terminal; and the control state-maintaining means may be configured so that the current of the control terminal is maintained at a predetermined current.

In the above-described power supply device, the controlling means may comprise a capacitor element that stores electric charge; and the control state-maintaining means may be configured so that voltages at both ends of the capacitor element is maintained at a predetermined voltage.

With the above-described configurations, during the second operation mode in which power supply is stopped, at least the state of a portion of the controlling means, for example, the gate voltage of the output transistor, a base current, a charge stored in the capacitor, or the like, is maintained to be a state corresponding to a state during the first operation mode. Accordingly, when entering the first operation mode in which power is supplied, a steady control state of the output voltage is quickly reached, and therefore, a rise time of the output voltage or the like can be shortened and the response characteristic at the start of the power supply can be improved.

The above-described power supply device may further comprises a current consumption-reducing means for reducing the current consumption of a portion of the controlling means that does not affect the operation of the control state-maintaining means during the second operation mode.

In the above-described power supply device, the current consumption-reducing means may be configured to cut off a current supply to a portion of the controlling means that does not affect the operation of the control state-maintaining means.

In the above-described power supply device, the portion of the controlling means that does not affect the operation of the control state-maintaining means may include a feedback circuit to which the output voltage is fed back, the feedback circuit generating a control signal for controlling the output voltage.

With the above-described configurations, the current consumption of the portion, such as a feedback circuit, that is required to operate only during the power supply is lowered by, for example, cutting off the current supply to that portion, and consequently, the current consumption of the power supply device itself can be reduced without degrading the response characteristic described above.

In the above-described power supply device, the current supply to the controlling means and the control state-maintaining means may be cut off during a third operation mode.

With the above-described configuration, the power supply device can be configured not to consume electric power in such a case that a high response characteristic at the start of power supply is not required. In addition, by preventing currents from flowing into the power supply device, a leakage test can be easily conducted to confirm if there is no leakage current.

In the above-described power supply device, the controlling means may comprise an operational amplifier; and the power supply device may further comprise a bias current controlling means for controlling a bias current in the operational amplifier.

In the above-described power supply device, the bias current may be controlled according to the output current of the power supply device.

In the above-described power supply device, the bias current may be controlled such that the larger the output current of the power supply device is, the larger the bias current.

With the above-described configurations, the response characteristic at the start of power supply can be further improved by increasing the bias current and the current consumption of the power supply device itself can be reduced by reducing the bias current. In particular, both a high speed response characteristic against sudden load fluctuations and a power consumption reduction in cases of relatively gradual load fluctuations, for example, can be achieved by controlling the bias current according to the output current of the power supply device.

In the above-described power supply device, the state corresponding to the first operation mode may be configured to be variable in a plurality of kinds of states.

In the above-described power supply device, the plurality of kinds of states may be set according to the magnitude of a load current during the first operation mode that is after the second operation mode.

With the above-described configurations, the state of the controlling means is set in various ways according to the magnitude of the load current or the like when entering the first operation mode, and as a result, the control of the output voltage is started more appropriately. Thus, the response characteristic at the start of power supply can be improved according to various load current fluctuations.

In accordance with another aspect of the present invention, a power supply device is provided comprising: a plurality of unit power supply devices supplying electric power to a given node of an apparatus to which power is to be supplied; wherein at least one of the plurality of unit power supply devices is such a power supply device as descried above that is a power supply device capable of maintaining a standby state.

With the above-described configuration, good response characteristic can be obtained when the power supply device enters the first operation mode in which the device supplies power, and therefore, it is possible to easily suppress a transient voltage drop in the voltage supplied to the load circuit.

In the above-described power supply device, the power supply device capable of maintaining a standby state may be switched between the second operation mode and the first operation mode according to a load current of the apparatus to which power is to be supplied.

With the above-described configuration, a current corresponding to the load current can be easily supplied.

In the above-described power supply device, the power may be supplied by a combination of one or more of the unit power supply devices that satisfies a current supply capability according to the load current of the apparatus to which power is supplied and minimizes the power consumption of the power supply device.

With the above-described configuration, a current corresponding to the load current can be easily supplied as described above, and in addition, the electric power consumed in the power supply device itself can be easily reduced.

In accordance with further another aspect of the present invention, a power supply device is provided comprising: a plurality of unit power supply devices supplying electric power to a given node of an apparatus to which power is to be supplied; wherein at least two or more of the plurality of unit power supply devices comprises one of the above-described power supply devices; and each of the two or more of the plurality of unit power supply devices has a different state of at least a portion of the controlling means that is maintained by the control state-maintaining means from one another.

In the above-described power supply device, when the combination of one or more of the unit power supply devices that supplies power is changed according to a fluctuation of a load current of the apparatus to which power is supplied, the combination may be changed into a combination such that a variation of an output voltage is minimized.

With the above-described configurations, the control of the output voltage can be started more appropriately by bringing the power supply device in which the state of the controlling means accords with the magnitude of the load current or the like into the first operation mode. Consequently, the response characteristic at the start of power supply can be improved according to various load current fluctuations, and therefore, it is possible to easily suppress a transient voltage drop in the voltage supplied to the load circuit.

In addition, the above-described power supply device may be formed in a single-chip semiconductor integrated circuit.

In the above-described power supply device, the power supply device may be formed in the same semiconductor integrated circuit as a semiconductor integrated circuit of the apparatus to which power is supplied.

With the above-described configurations, size reduction can be easily achieved in the power supply device as described above that supplies power according to the load current and that is capable of suppressing the power consumed by the power supply device itself. In addition, the capacitance of the power supply capacitor (bypass capacitor) is also reduced since good response characteristic can be obtained, and as a result, the power supply capacitor is easily integrated so that reductions in fabrication cost and in the device size can be achieved.

In accordance with yet another aspect of the invention, a power supply device is provided comprising: a controlling means for controlling an output voltage for supplying electric power at a predetermined voltage, the controlling means including an operational amplifier; and a bias current controlling means for controlling a bias current in the operational amplifier.

In the above-described power supply device, the bias current may be controlled according to an output current of the power supply device.

In the above-described power supply device, the bias current may be controlled so that the greater the output current of the power supply device is, the greater the bias current is.

With the above-described configurations, the response characteristic at the start of power supply can be further improved by increasing the bias current and the current consumption of the power supply device itself can be reduced by reducing the bias current. In particular, both a high speed response characteristic against sudden load fluctuations and a power consumption reduction in cases of relatively gradual load fluctuations, for example, can be achieved by controlling the bias current according to the output current of the power supply device.

### BRIEF DESCRIPTION OF THE DRAWINGS

FIG. 1A is a circuit diagram showing the configuration of a power supply device according to Embodiment 1 and the state during the first operation mode, and FIG. 1B is a circuit diagram showing the configuration of a power supply device according to Embodiment 1 and the state during a second operation mode.

FIG. 2A is a circuit diagram showing the specific configuration of a power supply device according to Embodiment 1 and the state during the first operation mode, and FIG. 2B is a circuit diagram showing the specific configuration of a power supply device according to Embodiment 1 and the state during the second operation mode.

FIGS. 3A to 3F are circuit diagrams showing the configuration of a reference voltage generating circuit 123 that generates a reference voltage Vref2 in the power supply device according to Embodiment 1.

FIG. 4 is a graph showing gate voltage and output voltage of an output transistor 125 in the power supply device according to Embodiment 1.

FIG. 5 is a graph showing output voltage of the power supply device according to Embodiment 1.

FIG. 6 is a graph showing output voltage of a conventional power supply device.

FIG. 7 is a circuit diagram showing the configuration of a power supply device according to Embodiment 2.

FIG. 8 is a circuit diagram showing the configuration of another power supply device according to Embodiment 2.

FIG. 9 is a circuit diagram showing the configuration of further another power supply device according to Embodiment 2 and the state during the first operation mode.

FIG. 10 is a circuit diagram showing the configuration of further another power supply device according to Embodiment 2 and the state during the second operation mode.

FIG. 11A is a circuit diagram showing the configuration of a power supply device according to Embodiment 3 and the state during the first operation mode, and FIG. 11B is a circuit diagram showing the configuration of the power supply device according to Embodiment 3 and the state during the second operation mode.

FIG. 12A illustrates a quiescent current during the first operation mode of the power supply device according to Embodiment 3, and FIG. 12B is illustrates quiescent current during the second operation mode of the power supply device according to Embodiment 3.

FIG. 13 is a circuit diagram showing another example of the power supply device according to Embodiment 3.

FIG. 14 is a circuit diagram showing the configuration of a power supply device according to Embodiment 3 having a third operation mode.

FIG. 15A is a circuit diagram showing the configuration of a differential operational amplifier 122 in the power supply device according to Embodiment 3, and FIG. 15B is a circuit diagram showing the configuration of a variable bias voltage generating circuit 434 in the power supply device according to Embodiment 3.

FIG. 16 is further another example of the power supply device according to Embodiment 3.

FIGS. 17A to 17C illustrate the relationship between load current and gate voltage of an output transistor 125 in a power supply device according to Embodiment 4.

FIGS. 18A to 18C are circuit diagrams showing the configuration of the reference voltage generating circuit 123 in the power supply device according to Embodiment 4.

FIG. 19 is a block diagram showing the configuration of a power supply device according to Embodiment 5 including a plurality of unit power supply devices.

FIGS. 20A to 20C illustrate the relationship between gate voltage of an output transistor 125 and load current during the first operation mode, according to Embodiment 5.

FIG. 21 illustrates an example of the operation mode transition in the power supply device according to Embodiment 5.

FIG. 22 is a schematic diagram showing an example of a power supply device according to Embodiment 6 that is formed in an LSI chip.

FIG. 23 is a schematic diagram showing another example of the power supply device according to Embodiment 6 that is formed in an LSI chip.

FIG. 24 is a diagram showing the configuration of a modified example of the power supply device.

FIG. 25 is a circuit diagram showing the configuration of a conventional power supply device.

FIG. 26 is a circuit diagram showing the configuration of another conventional supply device.

### DETAILED DESCRIPTION OF THE INVENTION

Preferred embodiments of the present invention are described below with reference to the attached drawings.

Embodiment 1

Outline of the Configurations

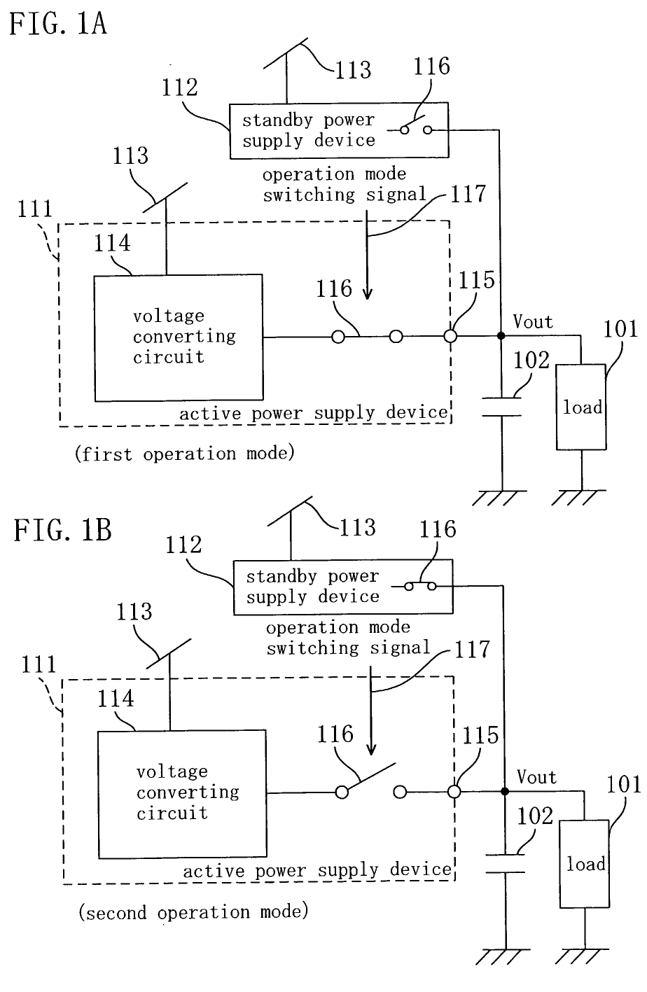

FIG. 1A is a circuit diagram showing the configuration of a power supply device according to Embodiment 1, illustrating the state in which an apparatus or the like to which power is supplied is, for example, in an active (normal operation) state. FIG. 1B likewise illustrates the state in which the apparatus or the like to which power is supplied is, for example, in a standby state.

In the figure, a load circuit 101 represents an apparatus or a circuit to which electric power is supplied, and a capacitor 102 represents a power supply capacitor (bypass capacitor). The power supply device that supplies electric power to the load circuit 101 has an active power supply device 111 (unit power supply device) and a standby power supply device 112 (unit power supply device).

The active power supply device 111 has a voltage converting circuit 114 (controlling means) and an output switch 116 (cutting-off means), the voltage converting circuit 114 converting a voltage supplied from a power supply 113 to a predetermined controlled voltage (which includes a stepped-up or a stepped-down voltage and substantially the same voltage), and the output switch 116 provided between the voltage converting circuit 114 and an output terminal 115. The output switch 116 is composed of, for example, a P-type MOS (metal oxide semiconductor) transistor, an N-type MOS transistor, or a transfer gate using both types of transistors, and is turned on/off in response to an operation mode switching signal 117 so as to be switched between a state in which electric power is supplied to the load circuit 116 (first operation mode) as shown in FIG. 1A and a state in which the power supply is stopped (second operation mode) as shown in FIG. 1B.

A standby power supply device 112 has a similar configuration to the active power supply device 111, and both devices serve the purpose of supplying electric power to the same node of the load circuit 101. The active power supply device 111 and the standby power supply 112 differ in their driving capabilities and their quiescent currents, and are configured so that the operation modes are switched according to load fluctuations. Specifically, the active power supply device 111 has a large driving capability but a large current consumption, whereas the standby power supply device 112 has a small current capability but a small current consumption. Accordingly, in the case of an active state in which the load circuit 101 consumes a relatively large power, for example, during the operation starting-up of the load circuit 101 or during the normal operation, the active power supply device 111 enters the first operation mode while the standby power supply device 112 enters the second operation mode to supply a required power (normal power supply state). In contrast, when the load circuit 101 is in a standby state, the active power supply device 111 enters the second operation mode while the standby power supply device 112 enters the first operation mode to supply a minimum power and to suppress the power consumption of the power supply device (low power supply state).

Specific Configuration of the Voltage Converter Circuit 114

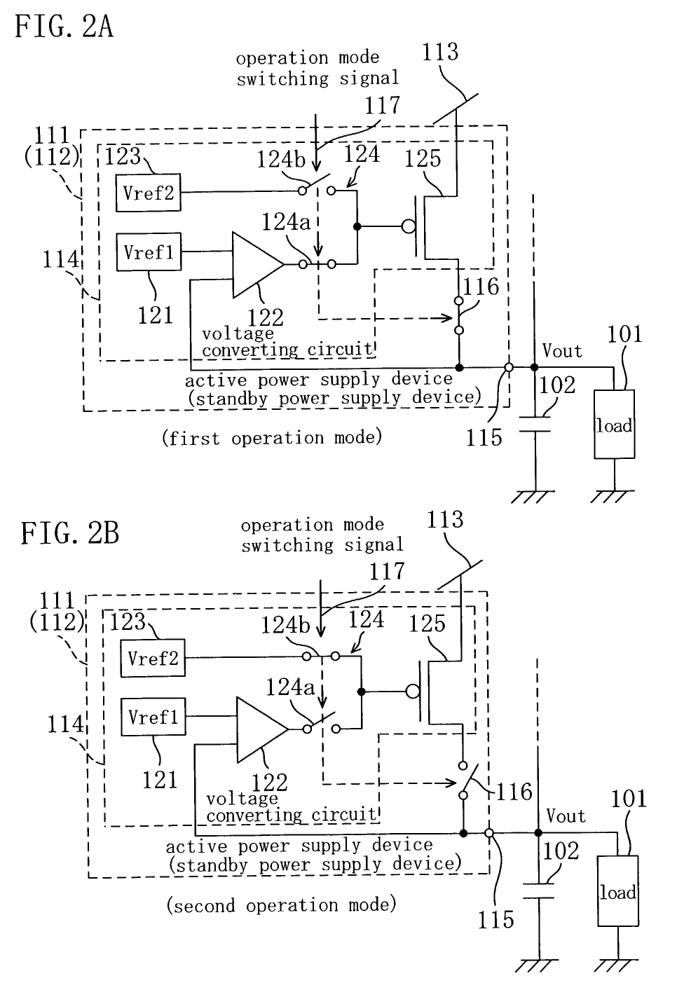

Specifically, the voltage converting circuit 114 comprises, for example as shown in FIGS. 2A and 2B:

a reference voltage generating circuit 121 that generates a reference voltage Vref1 that is to be output as an output voltage Vout;

a differential operational amplifier 112 that compares the output voltage Vout with the reference voltage Vref1 and outputs a voltage that corresponds to the difference therebetween;

a reference voltage generating circuit 123 (control state maintaining means) that generates a reference voltage Vref2, which is at substantially the same voltage as the voltage that is output from the differential operational amplifier 122 when the voltage converter circuit 114 is in the first operation mode and in a steady state, as will be detailed later;

a switch group 124 comprising switches 124a and 124b for selecting a voltage output from the differential operational amplifier 122 or a voltage output from the reference voltage generating circuit 123 in response to the same operation mode switching signal 117 as that controlling the output switch 116; and

an output transistor 125.

The gate terminal, the source terminal, and the drain terminal of the output transistor 125 are respectively connected to the switch group 124, the power supply 113, or the output switch 116, and the transistor outputs a voltage that is equal to the reference voltage Vref1 according to the voltage output from the differential operational amplifier 122 when the switch 124a enters a conducting state. The output transistor 125 is not particularly limited, though a P-type MOS transistor may be used, for example.

In addition, the switch 124a is not necessarily provided separately from differential operational amplifier 122 but may be configured such that the output becomes a high impedance inside the differential operational amplifier 122.

In addition, the following configuration is also possible. The reference voltage generating circuit 121 may output the reference voltage Vref1 and the reference voltage Vref2 in a variable manner and at the same time may be connected to the gate of the output transistor 125, so that it can also serve as the reference voltage generating circuit 123.

Specific Configuration of the Reference Current Generating Circuit 123

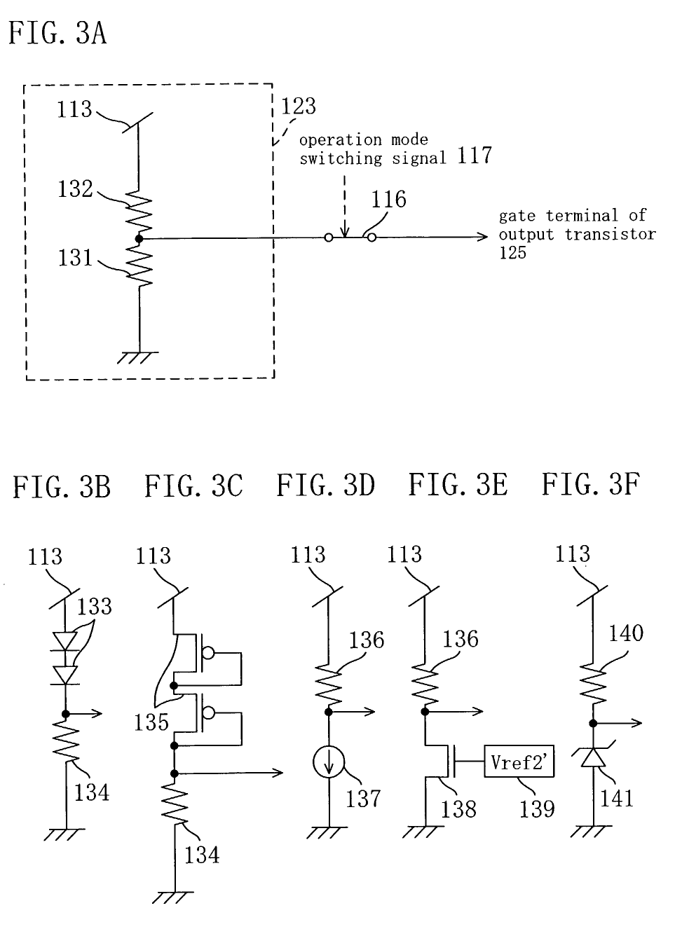

The reference voltage generating circuit 123, or the like, may be configured so that for example, the voltage of the power supply 113, or the like, can be divided using resistance elements 131 and 132 as illustrated in FIG. 3A. If this is the case, it is desirable that the resistance value of the resistance elements 131 and 132 be as large as possible (as large as the chip area permits, when formed in an LSI) in order to suppress the quiescent current consumption of the power supply device itself. In addition, as shown in FIG. 3B, it is possible to use one or more diodes 133 and a resistance element 134 so that a voltage that is reduced by the predetermined voltage from the voltage of the power supply 113 using a forward voltage drop in the diodes 133, or voltages at both ends of the diodes 133 may be used. The diode 133 may be composed of transistors 135 in each of which the gate is connected to the drain, as shown in FIG. 3C, for example. Also, as shown in FIG. 3D, a resistance element 136 and a constant current source 137 may be employed to utilize voltages generated at both ends of the resistance element 136, for example. The constant current source 137 may employ a transistor 138 and another reference voltage generating circuit 139, as shown in FIG. 3E, so that a desired reference voltage Vref2 can be generated utilizing a reference voltage (Vref2′) that is used in other portions in the power supply device or the like. Further, as shown in FIG. 3F, a resistance element 140 and a Zener diode 141 may be used, for example.

Operations of the Active Power Supply Device 111 in the First and the Second Operation Modes

In a case where the active power supply device 111 is in the first operation mode, i.e., in a case where it supplies a power that is required when the load circuit 101 is in an active state, the output switch 116 and the switch 124a are turned on whereas the switch 124b is turned off under the control of the operation mode switching signal 117, as shown in FIG. 2A. In this case, the output voltage Vout is fed back to the differential operational amplifier 122, and the differential operational amplifier 122 applies a control voltage to the gate terminal of the output transistor 125 so that the output voltage Vout becomes equal to the reference voltage Vref1. Then, the output transistor 125 converts the voltage of the power supply 113 into a voltage that is equal to the reference voltage Vref1, and the converted voltage is supplied to the load circuit 101.

When the active power supply device 111 is in the second operation mode, i.e., when the load circuit 101 is in a standby state and the power supply from the active power supply device 111 is not required, the output switch 116 is turned off to cut off the power supply while the switch 124a is turned off and the switch 124a is turned on to supply the reference voltage Vref2 to the gate terminal of the output transistor 125, as shown in FIG. 2B. As mentioned above, the reference voltage Vref2 is approximately the same voltage as a voltage that is output from the differential operational amplifier 122 (that is input to the gate terminal of the output transistor 125) when the voltage converting circuit 114 is in the first operation mode and in a steady state. Therefore, the output transistor 125 is maintained in substantially the same state as that in the first operation state, except that electric current does not flow between the source and the drain. As a result, when the active power supply device 111 is shifted to the first operation mode, a voltage that is equal to the reference voltage Vref1 is promptly supplied to the load circuit 101 as the output voltage Vout.

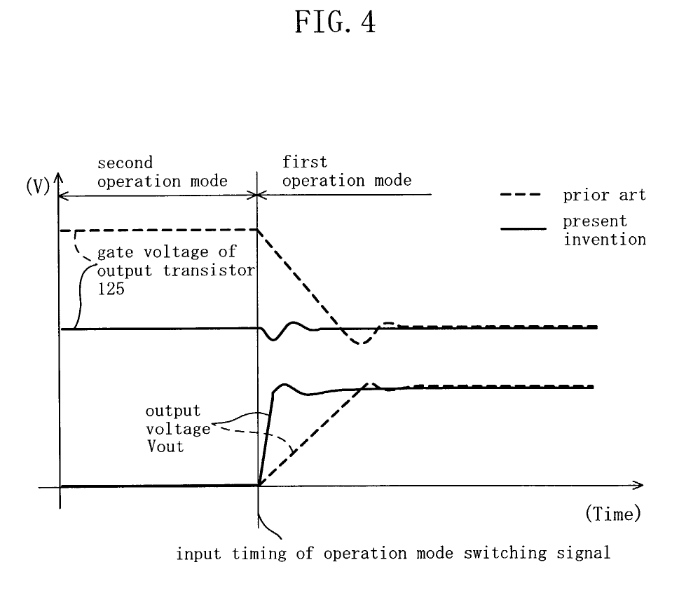

Specifically, in conventional cases where the gate voltage is shifted to H level (high level) to turn off the p-type MOS output transistor, when the feedback control signal is input to the gate terminal, the state in which the gate voltage has been stuck on H level does not immediately go away as shown by the broken line in FIG. 4, for example. Therefore, as is clearly seen from the figure, it takes a long time to obtain an appropriate output voltage. This tendency is more apparent particularly when the output current is large, since the size of the output transistor 125 is large and the parasitic capacitance is accordingly large. In contrast, when, as described above, the gate voltage of the output transistor 125 is maintained at the reference voltage Vref2 during the second operation mode, the gate voltage does not vary much after entering the first operation mode, and consequently, the output voltage Vout rises and the feedback control enters a steady state within a short time, so that a stable voltage supply is started, as shown by the solid lines in FIG. 4. It should be noted that the provision of the output switch 116 does not reduce the response speed because it can be turned on/off at high speed by driving it with an element having a large number of fan outs.

Operations of the Active Power Supply Device 111 and the Standby Power Supply Device 112

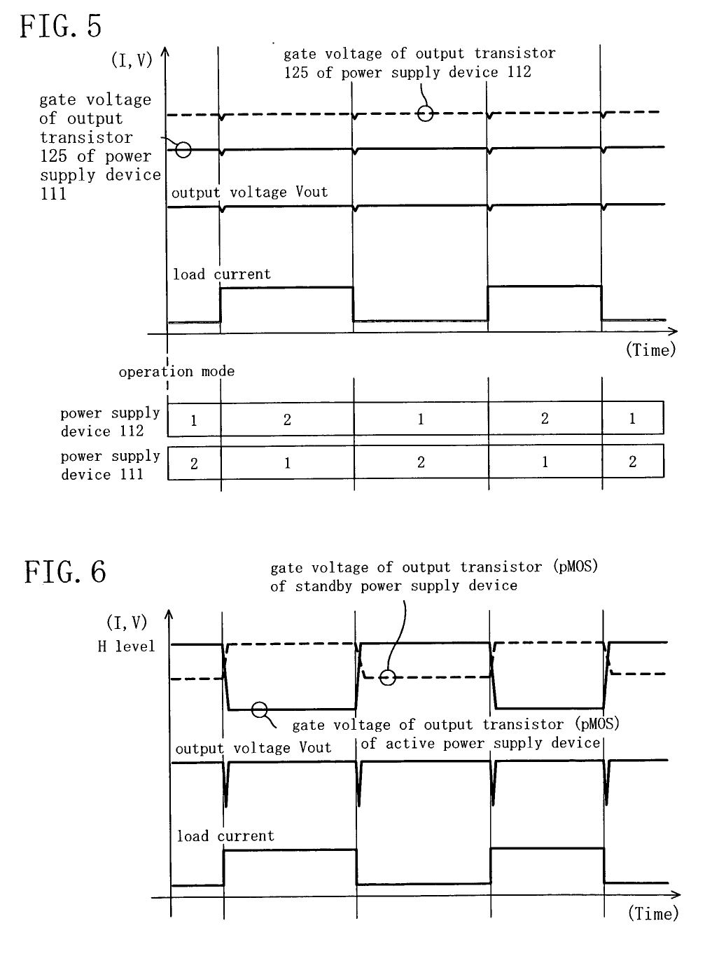

Both output voltages Vout of the active power supply device 111 and the standby power supply device 112 quickly rise as described above, and therefore, output voltage drops (and overshoots) do not easily occur when, for example, either of the active power supply device 111 and the standby power supply device 112 enters the first operation mode and the other enters the second operation mode according to load fluctuation. More specifically, for example as shown in FIG. 5, when a load current is small, the standby power supply device 112 enters the first operation mode and the active power supply device 111 enters the second operation mode, whereas when the load current is large, they are switched the other way round. Since the output voltage of one of the power supply devices that changes into the first operation mode rises at approximately the same time as the output voltage of the other power supply device that changes into the second operation mode drops. As a consequence, little decrease is seen in the output voltage Vout of the power supply device as a whole, as shown in the figure.

In contrast, as shown in FIG. 6, in the case where the gate voltage of the p-type MOS output transistor, for example, is turned to H level when the power supply is stopped as is the case with conventional power supply devices, the output voltage of the power supply device that is changed from a suspend state into a supply state requires a certain period of time until it rises as already described above, although the output voltage of the power supply device that has been in a power supply state drops relatively immediately. Therefore, a voltage drop is caused in the output voltage of the power supply device as a whole. In both cases where the load current increases and decreases, the voltage drop such as this similarly occurs according to the switching of the power supply devices. In view of this problem, it might be conceivable to delay one of the power supply devices entering the suspend state until the other power supply device that enters the power supply state reaches a steady state. However, even if a power supply device for a small power is maintained in a power supply state as the load current increases, it is difficult to suppress the reduction in the output voltage because its driving capability is small. Conversely, when a power supply device for a large power is maintained in a power supply state as the load current decreases, an excessive output voltage increase (overshoot) can be caused. For these reasons, it is difficult to maintain the output voltage at a constant level in such a case described above where the gate voltage of the p-type MOS output transistor, for example, is turned to H level when in a suspend state of power supply. It might also be conceivable that for example, a power supply device for a small power is constantly maintained in a power supply state, regardless of the load fluctuation, but this necessitates a wasteful quiescent current consumption. On the contrary, when the gate voltage of the output transistor 125 is maintained at a predetermined voltage as described above, a voltage drop in the output voltage Vout that occurs at the switching of the power supply devices according to step-like load fluctuations can be easily suppressed over a wide range of load current while a high current efficiency is maintained.

Embodiment 2

The foregoing embodiment 1 has described an example in which the voltage of the gate terminal of the output transistor 125 is maintained at a predetermined voltage during the second operation mode. The present embodiment describes an example configured such that nodes other than the gate terminal are also maintained at a predetermined voltage. In the following embodiments, similar parts to those of the foregoing embodiment 1 and so forth are designated by the same reference characters and are not further elaborated on.

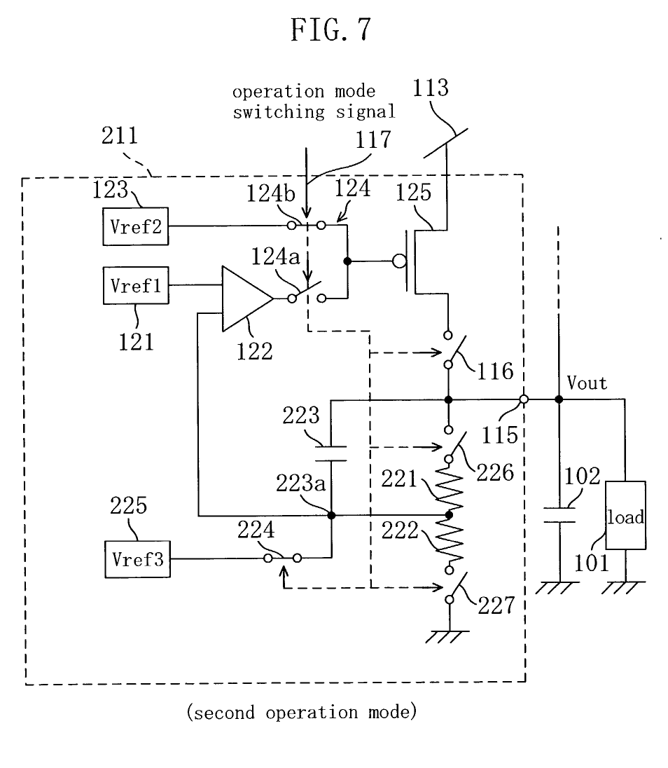

A power supply device 211 of Embodiment 2 is configured such that, as shown in FIG. 7 which shows the state during the second operation mode, the output voltage Vout is not directly supplied to the differential operational amplifier 122 unlike the power supply device of Embodiment 1, but the output voltage Vout is divided by resistance elements 221 and 222 (a voltage of the connecting points between the resistance elements 221 and 222) and is supplied thereto. When such a divided voltage is fed back, highly accurate output voltage can be easily obtained at 1.5 V or higher by using a bandgap reference at about 1.5 V for the reference voltage Vref1. A capacitor 223 is provided between the connecting point of the resistance elements 221 and 222 and the output terminal 115. A reference voltage generating circuit 225 that generates a reference voltage Vref3 is connected to the connecting point (in other words, a terminal 223a of the capacitor 223) via a switch 224. Further, switches 226 and 227 are provided at both sides of the resistance elements 221 and 222 for cutting off a leakage current path from the load circuit 101 and the reference voltage generating circuit 225 (from both ends of the capacitor 223) during the second operation mode.

In this power supply device 211, the reference voltage Vref1 that is supplied from the reference voltage generating circuit 121 to the differential operational amplifier 122 is equal to a voltage obtained by dividing the voltage to be output as the output voltage Vout using the resistance elements 221 and 222. Meanwhile, the reference voltage generating circuit 225 is configured so as to generate a reference voltage Vref3 that is substantially equal to the voltage of the terminal 223a of the capacitor 223 when the power supply device 211 is in the first operation mode and in a steady state (this voltage is consequently a voltage equal to the reference voltage Vref1). During the second operation mode, this reference voltage Vref3 is applied to the terminal 223a of the capacitor 223 via the switch 224.

In the power supply device configured in the above-described manner, when it shifts from the second operation mode to the first operation mode, the switches 124a, 116, 226, and 227 are turned on whereas the switches 124b and 224 are turned off. Under this condition, if electric charge has not been stored in the capacitor 223, the feedback control does not enter a steady state and an appropriate output voltage Vout cannot be obtained until a predetermined charge is stored. However, as described above, because the reference voltage Vref3 is applied to the terminal 223a of the capacitor 223 during the second operation mode, the capacitor 223 is maintained in a charged state that is approximately the same state as the steady state during the first operation mode. In addition, the gate voltage of the output transistor 125 is maintained at a reference voltage Vref2 as in Embodiment 1. Therefore, after entering the first operation mode, the output voltage Vout quickly rises and the feedback control quickly enters a steady state, so that a stable voltage supply can be started. Moreover, in cases where a plurality of power supply devices are switched, a voltage drop in the output voltage Vout can be easily suppressed.

Modified Example

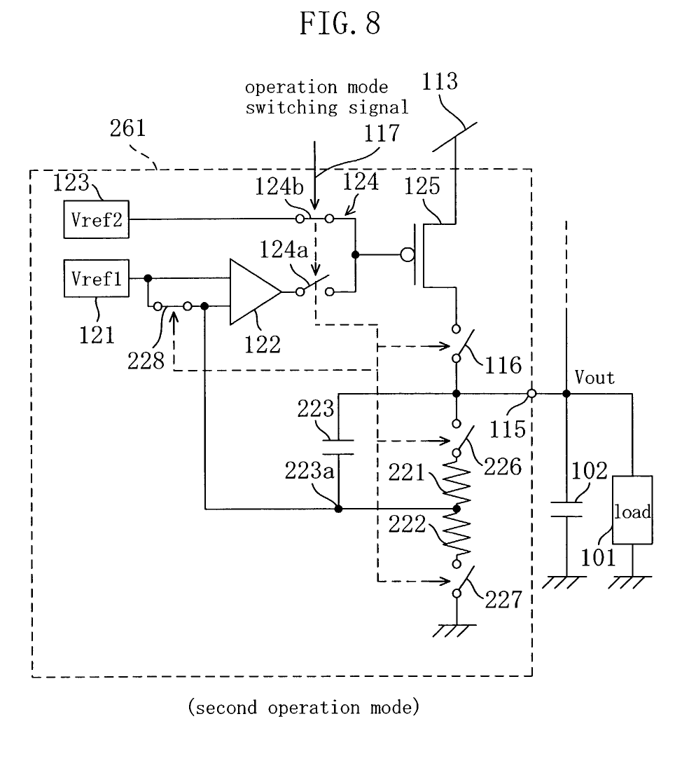

As discussed above, the reference voltage Vref3 is preferable to be set at a voltage substantially equal to the reference voltage Vref1. For this reason, the reference voltage generating circuit 121 may also serve as the reference voltage generating circuit 225, as shown in FIG. 8. Specifically, this is achieved by providing a switch 228 that is brought into a conducting state during the second operation mode to connect the output (the reference voltage Vref1) of the reference voltage generating circuit 121 and the terminal 223a of the capacitor 223. By employing this configuration, the same effects can be attained with a fewer number of elements than the previously-described configuration. It should be noted, however, that the reference voltage Vref1 has a larger influence on the accuracy of the output voltage Vout than the reference voltage Vref3. For this reason, in such cases that great accuracy and stability are required in the voltage control, it may be preferable that the reference voltage generating circuit 121 be provided independently as shown in FIG. 7.

Modified Examples in the Cases of a Plurality of Unit Power Supply Devices

When two or more unit power supply devices are provided and the output voltage Vout is divided and fed back to the differential operational amplifier in each unit power supply device in a similar manner, a voltage that is divided and used for the feedback in a unit power supply device that is in the first operation mode can be used for maintaining a voltage at a predetermined node of another unit power supply device that is in the second operation mode.

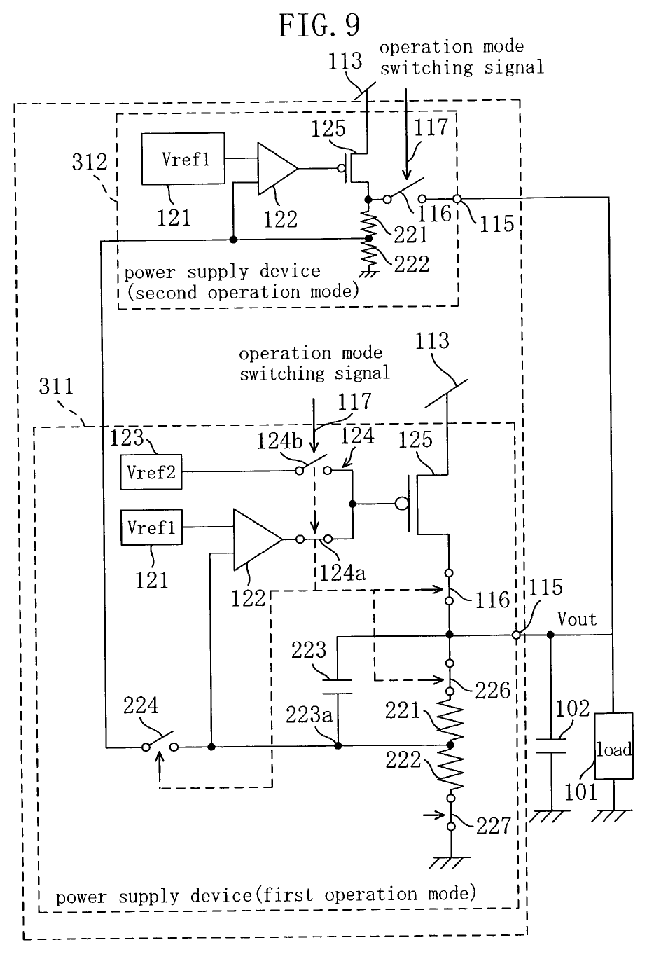

Referring to FIG. 9, a power supply device 311 has a similar configuration to the power supply device 211 of the above-described example (FIG. 7), and the only difference is that a voltage that is input from a power supply device 312 via the switch 224 is used in place of the reference voltage Vref3 generated by the above-described reference voltage generating circuit 225.

Like the power supply device 311, the power supply device 312 is configured such that the output voltage Vout is divided by the resistance elements 221 and 222 and is fed back to the differential operational amplifier 122, and the divided voltage is given to the switch 224 of the power supply device 311. It should be noted that, for the sake of simplicity in illustration, the figure depicts an example of the power supply device 312 in which the switches 226 and 227, and the capacitor 223 are not provided and the state inside is not maintained in the same state as that in the first operation mode, but the present invention is not so limited, and a power supply device having a similar configuration to the power supply device 311 may be employed.

With this configuration, when the power supply device 311 is in the first operation mode, the switch 224 is brought into a non-conducting state and the operation is exactly the same as the above-described power supply device 211; the output voltage Vout controlled by the output transistor 125 is output to the load circuit 101. Under this confidtion, in the power supply device 312, the output switch 116 is brought into a non-conducting state, and consequently the power supply device 312 enters a state in which it stops the power supply.

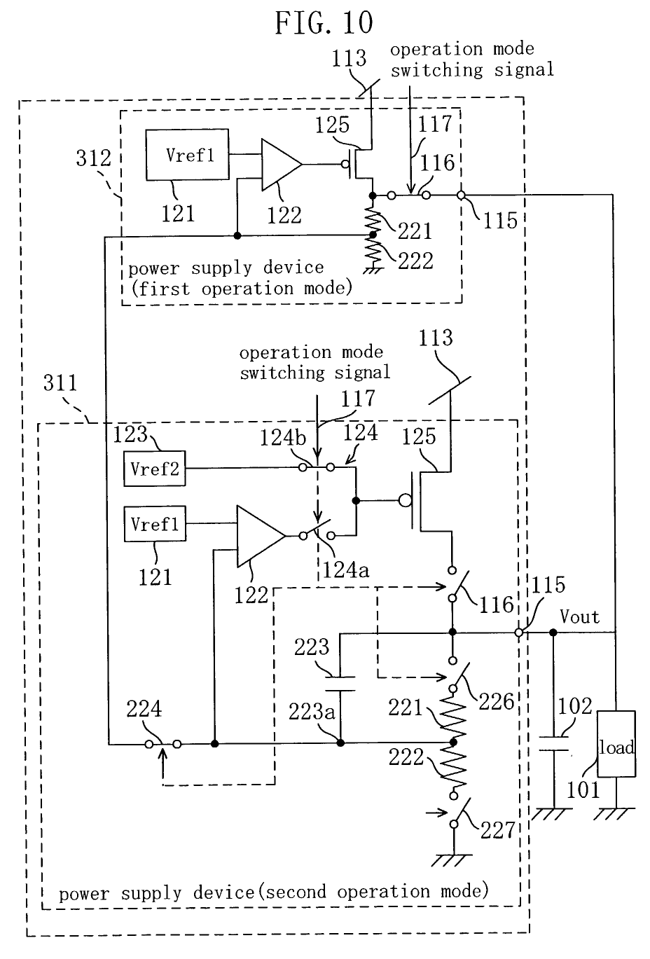

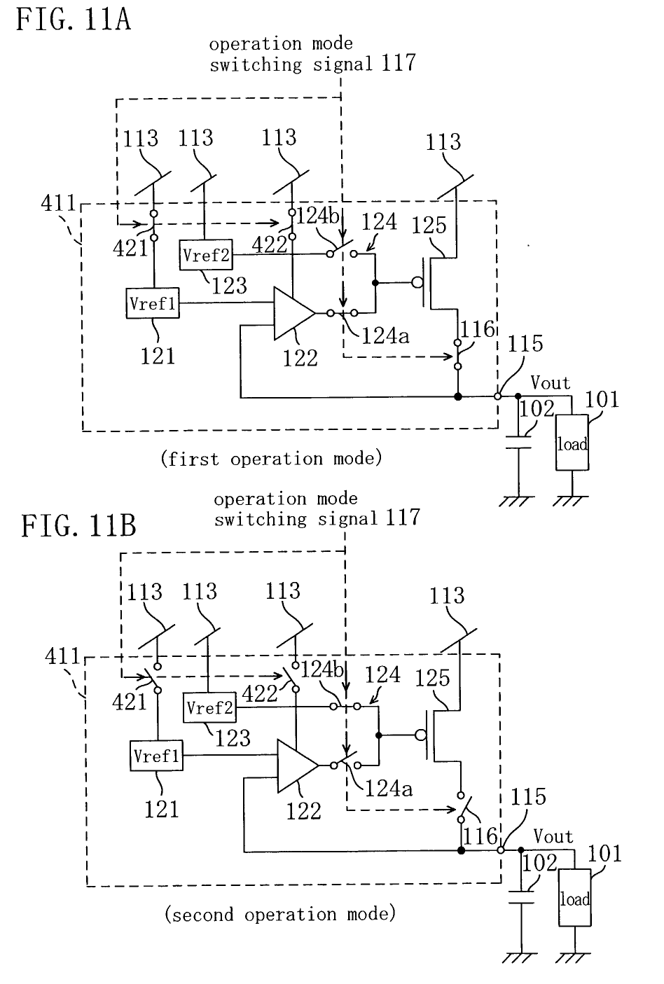

In contrast, when the power supply device 311 enters the second operation mode and the power supply device 312 enters a state in which it supplies power, the switch 224 is, as shown in FIG. 10, brought into a conducting state so that the voltage at the connecting point of the resistance elements 221 and 222 in the power supply device 312 is applied to the terminal 223a of the capacitor 223 via the switch 224. Accordingly, the capacitor 223 is maintained at approximately the same voltage at both ends (in a charged state) as in the steady state in the first operation mode. In addition, the gate voltage of the output transistor 125 is maintained at the reference voltage Vref2 by the reference voltage generating circuit 123. Therefore, when entering the first operation mode, a stable voltage supply can be quickly started and a voltage drop in the output voltage Vout can be suppressed. It should be noted that even when the voltage of the capacitor at both ends thereof is maintained in the above-described manner, a wasteful quiescent current consumption does not occur since there is no current path.

Embodiment 3

As well as the foregoing embodiments, Embodiment 3 describes a power supply device that can improve the response characteristics when the device is switched from the second operation mode to the first operation mode and can reduce power supply device during the second operation mode.

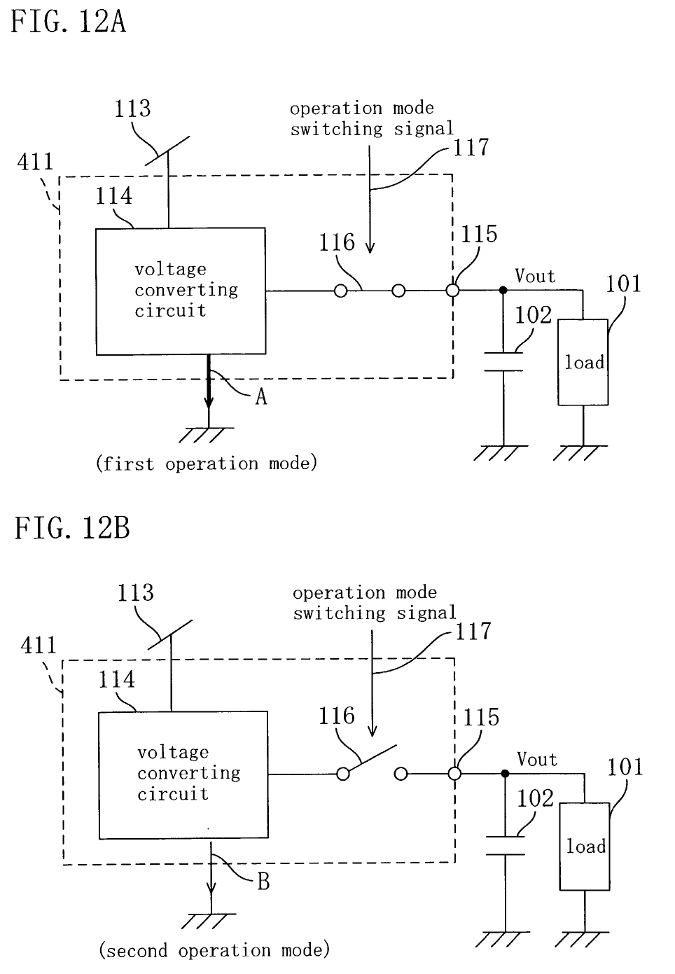

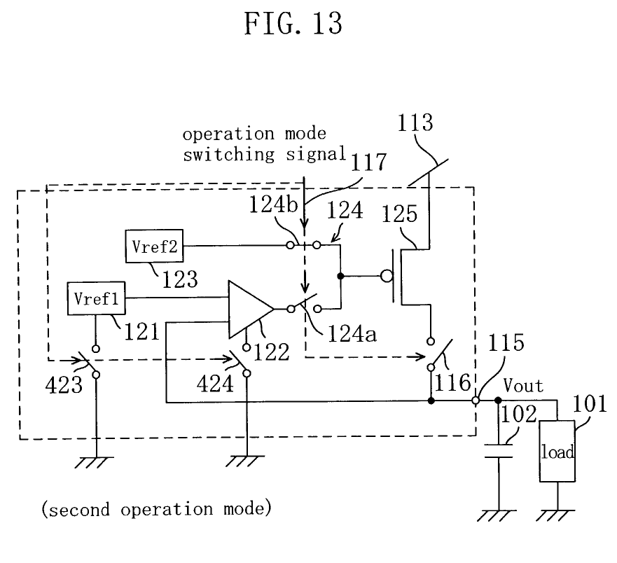

Referring to FIGS. 11A and 11B, a power supply device 411 is similar to the active power supply device 111 according to the foregoing embodiment 1 (FIG. 2), but differs therefrom in that switches 421 and 422 (power consumption reducing means) are provided, for example, between the power supply device 113 and the reference voltage generating circuit 121 and between the supply device 113 and the differential operational amplifier 122, respectively. The switches 421 and 422 are brought into a conducting state during the first operation mode as shown in FIG. 11A to supply power to the load circuit 101 exactly in the same operation as that of the active power supply device 111. On the other hand, during the second operation mode, the switches 421 and 422 are brought into a non-conducting state as shown in FIG. 11B to cut off the power supply to the reference voltage generating circuit 121 and the differential operational amplifier 122, etc. However, the reference voltage generating circuit 123 needs to maintain the gate voltage of the output transistor 125 as described above and is therefore kept connected to the power supply 113. As a result, the current (quiescent current) required for the operation of the power supply device 411 itself during the first operation mode and during the second operation mode is as shown in FIGS. 12A and 12B; the current during the second operation mode (as represented by B in the figure) can be reduced to at least the same level to that during the first operation mode (as represented by A in the figure) or lower, and can even be easily reduced to a remarkably lower level.

As described above, the connections to the power supply 113 are brought into an OFF state to cut off the current paths of the power supply except the portion that is required to improve the response characteristic when entering the first operation mode, and thereby, the power consumption during the second operation mode can be reduced without degrading the response characteristic.

It should be noted that, in place of providing the switches 421 and 422 for cutting off the current paths that has little or no effect on the response characteristic at the power supply 113 sides, switches 423 and 424 may be provided at the grounding side. It is also possible to provide the switches both at the power supply side and at the grounding side.

In addition, the power supply to the reference voltage generating circuit 123 for maintaining the gate voltage of the output transistor 125 at the reference voltage Vref2 may be cut off during the first operation mode in a similar manner.

Example of a Power Supply Device Having a Third Operation Mode

In the following, a power supply device is discussed which has a third operation mode (non-operating mode), in addition to the first and the second operation modes, in which power is not supplied to the load circuit 101 and there is no quiescent power consumption.

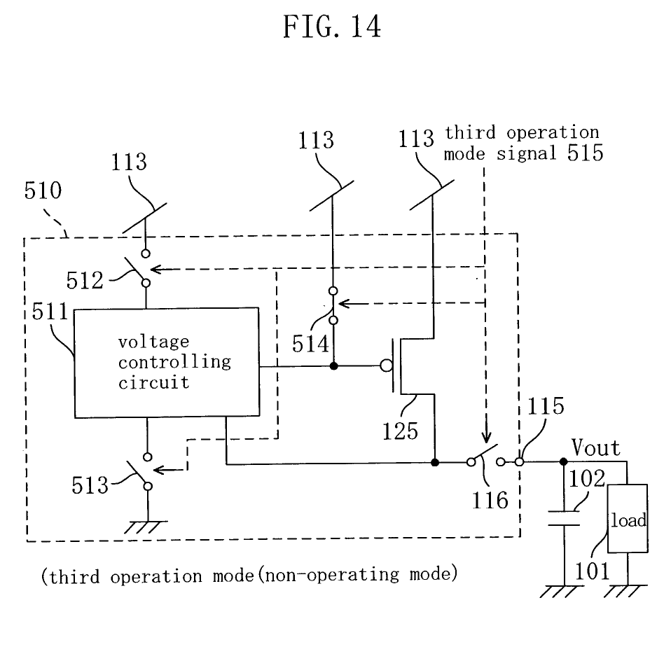

A power supply device 510 has, for example, a voltage controlling circuit 511, an output transistor 125, an output switch 116, an output terminal 115, and switches 512 to 514, as shown in FIG. 14. The voltage controlling circuit 511 has a reference voltage generating circuit, a differential operational amplifier, and so forth such as described in the foregoing embodiments, and is configured to be switched between the first and the second operation modes in a similar manner to the active power supply device 111 (of FIG. 2) etc. In addition, in response to a third operation mode signal 515, the switches 512 and 513 are turned off to cut off all the current paths from the power supply 113 while the switch 514 is turned on to fix the voltage of the gate terminal of the output transistor 125 at the voltage of the power supply 113, so that the output transistor 125 is turned off, and the output switch 116 is turned off. Thus, the third operation mode is entered in which there is no power supply or no quiescent power consumption. It should be noted here that, in place of fixing the voltage at the gate terminal, the source of the output transistor 125 may be cut off from the power supply 113. When these switches are formed on a p-type semiconductor substrate, it is preferable that the switch 512 at the power supply side be a p-type MOS transistor switch, the switch 513 at the grounding side be a n-type MOS transistor switch, and the output switch 116 be a transfer gate using both p-type and n-type MOS transistor switches, although various other configurations are possible.

The above-described third operation mode can be used, for example, when power does not need to be supplied immediately to the load circuit, to prevent power consumption of the power supply device itself. In addition, by preventing currents from flowing into the power supply device in this manner, a leakage test can be easily conducted to confirm if there is no leakage current.

Another Example Capable of Reducing Power Consumption

An example of a differential operational amplifier 122 is discussed which can easily attain both an improvement of response characteristic and a reduction in quiescent current consumption.

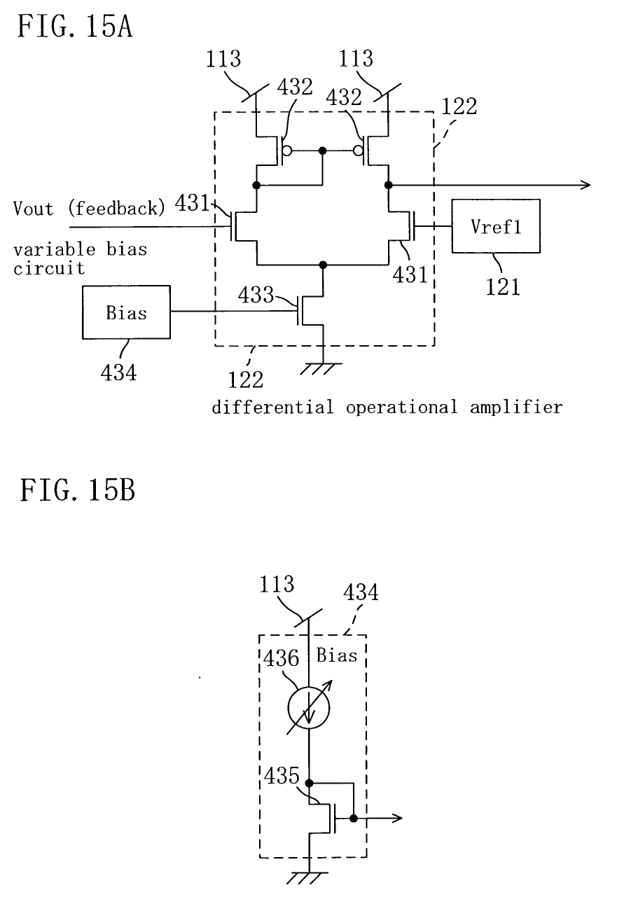

The differential operational amplifier 122 of this example is, for example as shown in FIG. 15A, configured to have n-type MOS transistors 431, 431 that constitute a differential amplifier circuit, p-type MOS transistors 432, 432 that constitute a current mirror circuit, and an n-type MOS transistor 433 that controls a bias current. To the gate of the n-type MOS transistor 433, a variable bias voltage-generating circuit 434 (bias current controlling means) is connected. The variable bias voltage-generating circuit 434 has, for example as shown in FIG. 15B, an n-type MOS transistor 435 that constitutes a current mirror circuit together with the n-type MOS transistor 433, and a current source 436 that is variable in response to a load current flowing in the load circuit 101, an operation switching signal, or the like.

With this configuration, the variable bias voltage-generating circuit 434 outputs a voltage corresponding to the current supplied by the current source 436, and a bias current corresponding to this voltage flows in the differential operational amplifier 122.

Accordingly, for example, if the voltage output from the variable bias voltage-generating circuit 434 is made low when the load current flowing in the load circuit 101 is small or when the power supply device is in the second operation mode, the bias current of the differential operational amplifier 122 becomes small, and thus power consumption is reduced. On the other hand, if the voltage output from the variable bias voltage-generating circuit 434 is made high when the load current is large or when the power supply device is in the first operation mode, the bias current becomes large and thus the response characteristic of the differential operational amplifier 122 increases; therefore a stable voltage can be easily output even at the switching between the operation modes or at sudden load fluctuations.

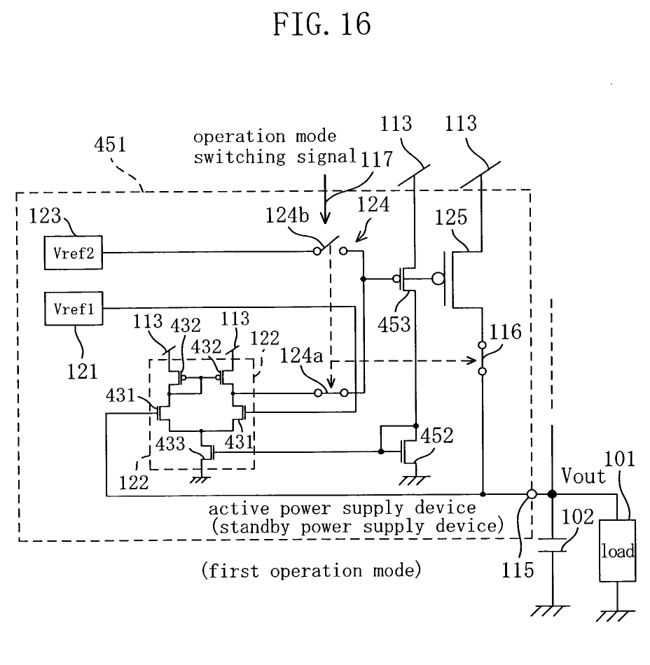

The bias current of the differential operational amplifier 122 may be controlled through feedback control according to the magnitude of the load current. Specifically, for example, a power supply device 451 shown in FIG. 16 uses a differential operational amplifier 122 that is shown in FIG. 15 as the differential operational amplifier 122 of the active power supply device 111 shown in FIG. 2. In addition, the power supply device 451 has an n-type MOS transistor 452 that constitutes a current mirror circuit together with the n-type MOS transistor 433 of the differential operational amplifier 122, and a p-type MOS transistor 453 that supplies a current corresponding to the gate voltage of the output transistor 125 to the n-type MOS transistor 452. In the power supply device 451 thus configured, as the voltage applied to the gate of the output transistor 125 (and the gate of the p-type MOS transistor 453) is lower, in other words, as the load current is larger (in this case, the fluctuation of the load current is generally large), the bias current flowing via the n-type MOS transistor 433 of the differential operational amplifier 122 becomes larger and therefore the response characteristic improves. Thus, it is easily made possible to achieve a power supply that can follow sudden load fluctuations. On the other hand, when the load current is small, the bias current becomes small and power consumption can be therefore reduced. In this example, in addition to the control of the bias current according to the load current, the device may be configured to forcibly vary the bias current or the mirror ratio of the n-type MOS transistors 433 and 452 may be configured to be variable. Moreover, if the configuration as described above is applied to the previously-described configuration of FIG. 7, stability is further improved since instability in the feedback control can be suppressed by the improvement in the response characteristic.

Embodiment 4

To be precise, in the power supply devices described in Embodiment 1 etc., for example, the gate voltage of the output transistor 125 during the first operation mode changes according to the magnitude of the load current flowing in the load circuit 101. Therefore, in the case where the magnitude of the load current during the first operation mode is known beforehand, the fluctuation of the output voltage Vout after the operation mode switching can be suppressed more reliably if a voltage corresponding to the magnitude of the load current is generated as the reference voltage Vref2 or the like and is applied to the gate terminal of the output transistor 125 or the like, when entering the first operation mode from the second operation mode.

The case where the magnitude of the load current is known beforehand refers to such a case that, for example, when the apparatus that is the load circuit 101 enters an active state, the circuits or the like operating under the active state can be specified according to the conditions of the apparatus, the environment, or the like. More specifically, such a case is included, for example, that it has been determined that when the apparatus enters an active state, the operation control portion and the display portion are in an operating state. In such cases, the magnitude of the load current can be easily determined or estimated.

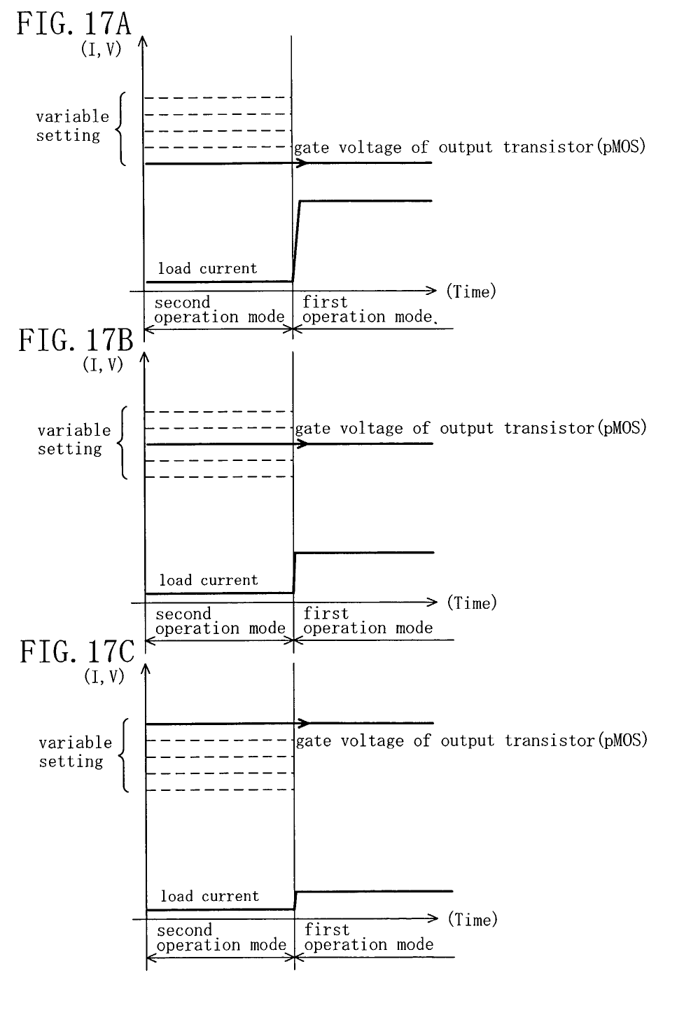

Next, a specific example is described in which the reference voltage Vref2 is determined according to the magnitude of the load current. The gate voltage of the output transistor 125 during the first operation mode becomes lower when the load current is larger in the case of a p-type MOS transistor. In consideration of this, for example as shown in FIGS. 17A to 17C, in the second operation mode, a voltage corresponding to a presupposed load current is generated as the reference voltage Vref2, and the generated voltage is input to the gate terminal of the output transistor 125. Thus, as seen in the figure, the gate voltage does not fluctuate when entering the first operation mode, and consequently, upon entering the first operation mode, a steady state is quickly attained and a stable voltage supply is started.

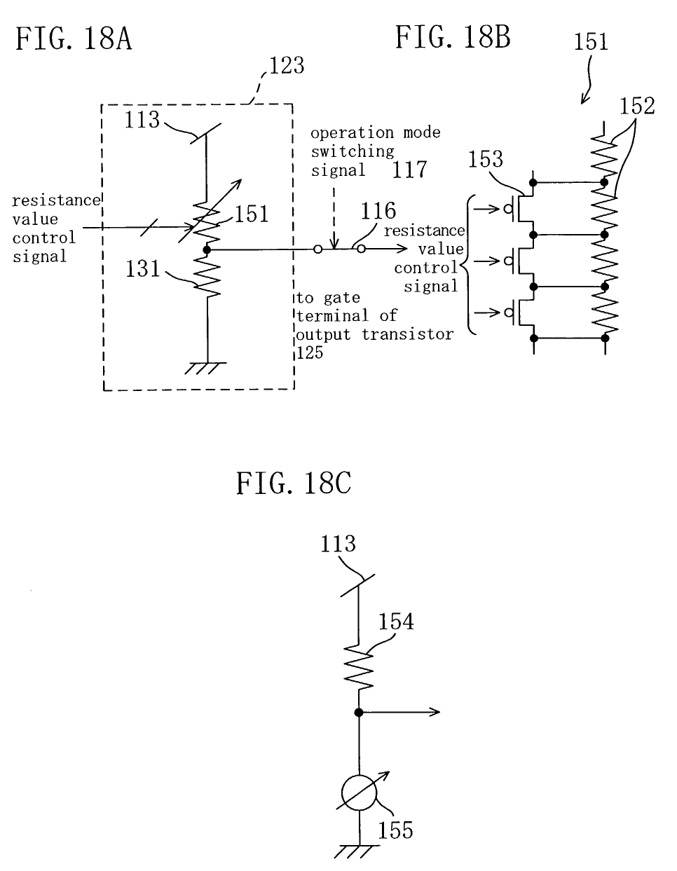

The reference voltage generating circuit 123 that generates a variable reference voltage Vref2 may be configured, as shown in FIG. 18A, such that the voltage of the power supply 113, etc. is divided by the resistance element 131 and a variable resistance element 151 in which the resistance value varies in response to a resistance value controlling signal. The variable resistance element 151 can be configured by connecting the sources and the drains of p-type MOS transistors 153 to either end of resistance elements 152 that are connected in series, as shown in FIG. 18B, and the resistance value as a whole is made variable by turning on/off the p-type MOS transistors 153 with the resistance value controlling signal. Alternatively, as shown in FIG. 18C, using a resistance element 154 and a variable current source 155, a voltage that is generated at either end of the resistance element 154 may be utilized.

Embodiment 5

Embodiment 5 describes an example of a power supply device that comprises a greater number of various unit power supply devices and can supply power according to a plurality of load current states in the circuits or devices to which power is supplied. Specific examples of the plurality of load current states include, for example in the case of computers or the like, an active state in which normal operation is performed (including a state in which hard disks are operated, a state in which data transmission is carried out via networks, a state in which keyboards are operated, and so forth), a state called “sleep” or “standby” in which surface operations are suspended while the states and data inside are retained, a shut-down state in which virtually all the operations are shut down except small portion of the functions such as a timekeeping function, and so forth. In the case of mobile telephones, the plurality of load current states include a talk state that accompanies the transmission of radio waves, a standby state in which only incoming transmission and operating inputs are accepted, and a shut down state in which all the operations except data retention are shut down. In addition, even in a single device, LSIs that constitute the device may enter separate operating states.

Configuration of a Power Supply Device Including a Plurality of Unit Power Supply Devices

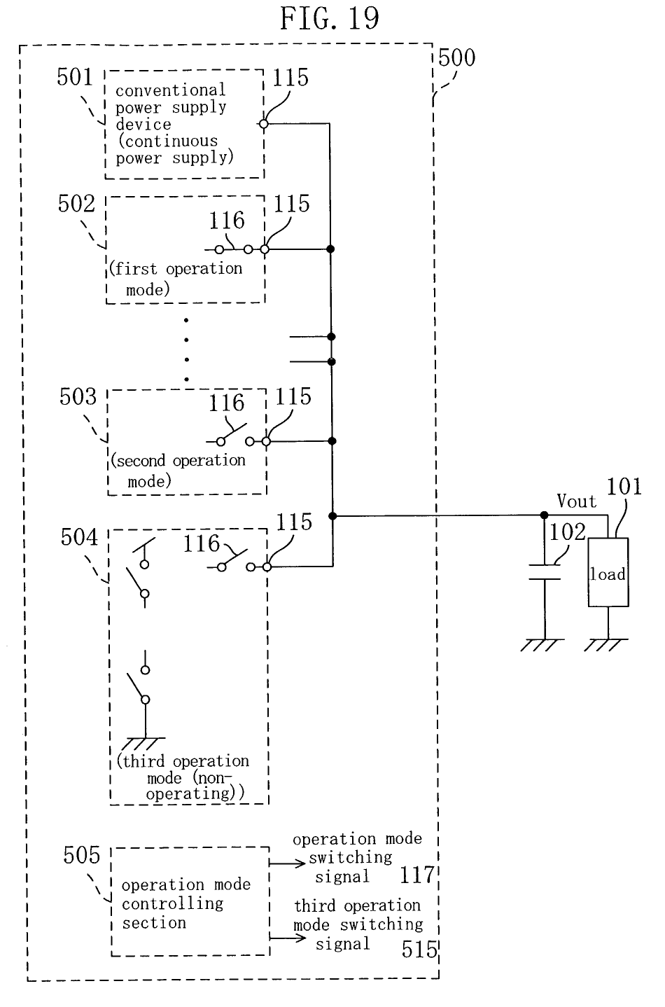

As shown in FIG. 19, a power supply device 500 is provided with four or more power supply devices 501 to 504, etc. each being a unit power supply. The output terminals 115 of the power supply devices 501 to 504 are connected to each other so that an output voltage Vout can be supplied to the load circuit 101. The power supply device 500 is also provided with an operation mode controlling unit 505 that controls the operation modes or the like of the power supply devices 502 to 504. The operation mode controlling unit 505 may be configured to control the operation modes based on the operating states and operating sequences of the load circuit 101, or may be configured to control the operation modes by detecting the actual load current flowing in the load circuit 101.

The power supply device 501 is a power supply device that has only the first operation mode and supplies power continuously as conventional devices, and such a power supply device may be used in the power supply device 500. In addition, it is also possible to use a power supply device that enters a power suspend state merely by cutting off the power supply voltage (a power supply device that does not have a good response characteristic but has a simple construction) according to the intended use or the like of the circuit or apparatus that is the load circuit 101. Furthermore, a power supply device that outputs a different voltage from the voltages output from the other power supply devices may be used when, for example, the supplied voltage needs to be varied according to the conditions or the like of the load circuit 101.

The power supply devices 502 and 503 are such power supply devices as described in the foregoing embodiments having the first and the second operation modes, and the power supply device 504 is a power supply device having the first to the third operation modes.

Selection of the Power Supply Device that is Brought into the First Operation Mode

Next, the selection of a plurality of power supply devices 502, etc. is explained below.

First, it is necessary that the power supply device(s) 502, etc. that is/are selected to supply power (that enter/enters the first operation mode) have a current capacity according to the load current flowing in the load circuit 101. Here, the power supply device(s) to be selected is not limited to one device, but a plurality of devices may be selected in combination. Specifically, when the output voltages from the devices are equal, the resultant current capacity is the total of the capacities of the power supply devices 502, etc., and therefore, it is only necessary that this resultant current capacity is an amount that corresponds to the load current flowing in the load circuit 101. However, when power supply devices having different output voltages are present, it is necessary that a power supply device having a different output voltage be not connected to another power supply device.

In addition, when there are a plurality of combinations that satisfy a required current capacity, it is preferable that a combination having a small quiescent current be selected. Specifically, when the power supply devices 502, etc. are in the second operation mode, the power supply devices 502, etc. themselves consume electric power as mentioned above, though the amount is insignificant. Accordingly, in order to select the optimum combination of the power supply devices 502, etc., it is preferable that the grand total of the total quiescent current of the power supply devices 502, etc. that enter the first operation mode and the total quiescent current of the power supply devices 502, etc. that enter the second operation mode be minimized.

Specifically, for example, regarding power supply devices P and Q, assuming that:

in the power supply device P, the quiescent currents consumed during the first operation mode and the second operation mode are 10 mA and 1 mA, respectively, and

in the power supply device Q, the quiescent currents consumed during the first operation mode and the second operation mode are 15 mA and 12 mA, respectively,

(1) when the power supply device P is in the first operation mode whereas the power supply device Q is in the second operation mode, the total of the current consumed is:

10mA+12mA=22mA.

(2) on the other hand, when the power supply device Q is in the first operation mode whereas the power supply device P is in the second operation mode, the total of the current consumed is:

1mA+15mA=16mA.

In other words, the power supply device P has a smaller quiescent current in the case where power is supplied in the first operation mode, but under this condition, if the power supply device Q enters the second operation mode, a quiescent current of 12 mA flows, and accordingly, the power consumption as a whole can be reduced if power is supplied by the power supply device Q.

Thus, by selecting optimum power supply devices so that a required current capacity is satisfied and the quiescent current consumption of the whole power supply device is minimized, a voltage drop in the output voltage Vout can be suppressed and a high current efficiency can be obtained over a wide range of load current.

Selection According to the Retained Gate Voltage

For example, when two or more of the power supply devices 502 to 504 have a required current capacity, the reference voltage Vref2 that is applied to the gate terminal of the output transistor 125 may be varied by the reference voltage generating circuit 123, and, according to the voltage and the load current, the optimum power supply devices can be selected from the power supply devices 502 to 504.

It should be noted here that fluctuations of the gate voltage and the output voltage Vout after switching the operation modes can be suppressed by setting the gate voltage according to the load current, and this principle is the same as described in the foregoing embodiment 4 (FIG. 17). In other words, the foregoing embodiment 4 has described an example in which the gate voltage is set to be variable in one power supply device, but the present embodiment achieves similar effects by setting predetermined gate voltages for the respective power supply devices 502 to 504. (It should be noted that, in addition, each of the power supply devices 502 to 504 may be configured to have a variable gate voltage, as in the manner shown in Embodiment 4.)

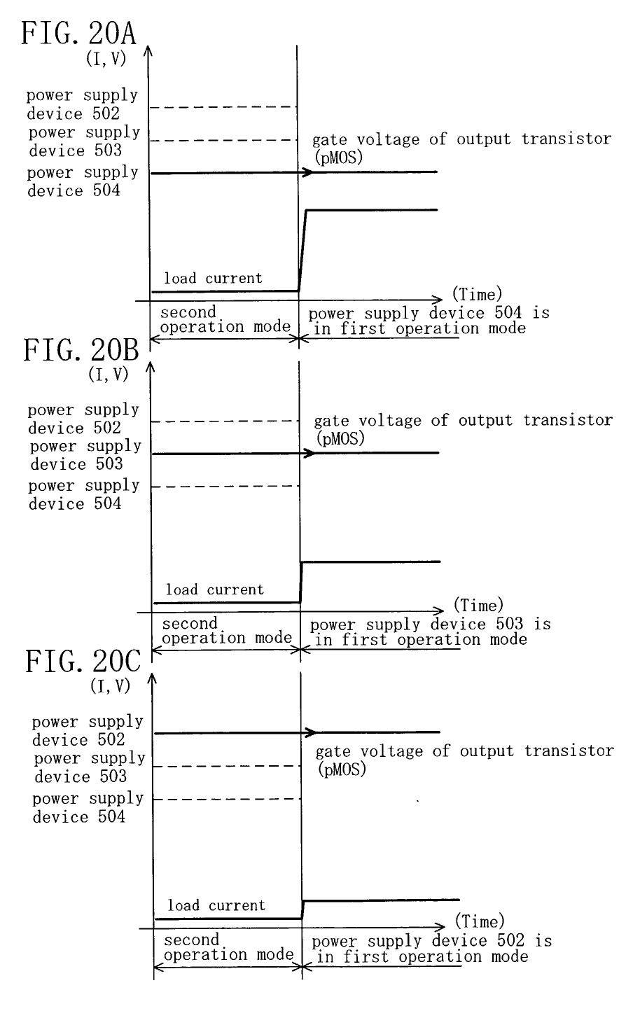

FIGS. 20A to 20C illustrate the relationship between the gate voltage of the output transistor 125 and the load current in the first operation mode. As seen from the figure, in response to the load current that has fluctuated, optimum power supply devices are selected from the power supply devices 502, etc. such that variation in the output voltage is minimized according to the load current that has fluctuated, and the selected power supply devices enter the first operation mode. Thus, even after the switching of operation modes, the gate voltage shows little fluctuation, and therefore, a steady state can be quickly reached and a stable voltage supply is started. It should be noted that those power supply devices that have not been selected may remain in the second operation mode, or may enter the third operation mode.

As described above, when at least one or more power supply devices 502, etc. are selected according to the gate voltage to enter the first operation mode, a smooth switching from the second operation mode to the first operation mode can be ensured without fluctuations in the gate voltage of the output transistor, and a voltage drop in the output voltage Vout can be suppressed.

Example of Operation Mode Transition

Discussed below is an example of transition of operation modes in the power supply devices 501, etc. in response to load current fluctuations.

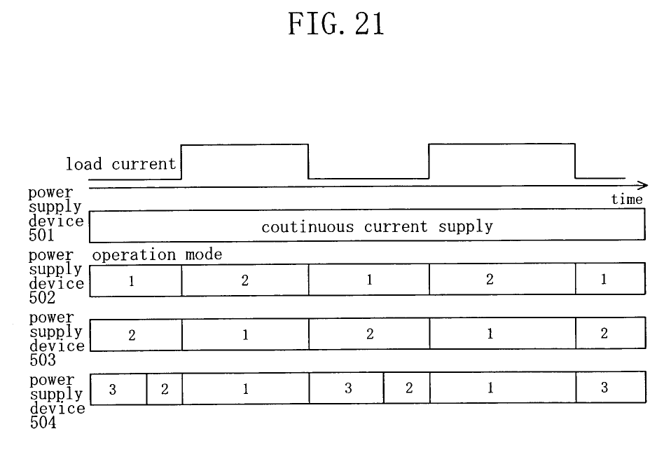

If the load current of the load circuit 101 changes as shown in FIG. 21, for example, operation modes of the power supply devices 502 to 504 accordingly changes. (The power supply device 501 is continuously in a power supply state and is therefore not further elaborated in the following discussion.)

When the load current is small, the power supply device 502, for example, enters the first operation mode to supply power to the load circuit 101. Under this condition, the power supply device 503 enters the second operation mode and the quiescent current consumption is suppressed. In addition, the power supply device 504 having three operation modes enters the third operation mode if it is found that the load current does not increase, and the quiescent current consumption is further suppressed. The power supply device 504 enters the second operation mode in advance if it is found that the load current increases or if there is a possibility that the load current increases, in order to prepare for the start of power supply. More specifically, for example in the case of a mobile telephone, the power supply device that supplies electric power to the transmitter circuit is in the third operation mode during the standby state of the telephone, but when the key operation is carried out, the power supply device enters the second operation mode since transmission might be subsequently performed.

Then, when the load current increases, the power supply devices 503 and 504 are shifted from the second operation mode to the first operation mode while the power supply device 502 enters the second operation mode. Thus, a required power supply is promptly started without causing a voltage drop in the output voltage Vout or the like.

When the load current decreases, the power supply devices 503 and 504 are shifted back to the second operation mode and the third operation mode, respectively, but in this case as well, the power supply device 502 is shifted from the second operation mode to the first operation mode, so that power supply is quickly started. Thus, even when the power supply from the power supply devices 503 and 504 suddenly stops, a voltage drop in the output voltage Vout or the like is prevented. In this case, when the power supply device 504 stops power supply, it may enter either the second operation mode or the third operation mode. In other words, either operation mode may be selected according to the possibility of a load current increase or the like.

Embodiment 6

Embodiment 6 describes examples of the forms of mounting the above-described power supply devices on an LSI (large scale integrated circuit) chip.

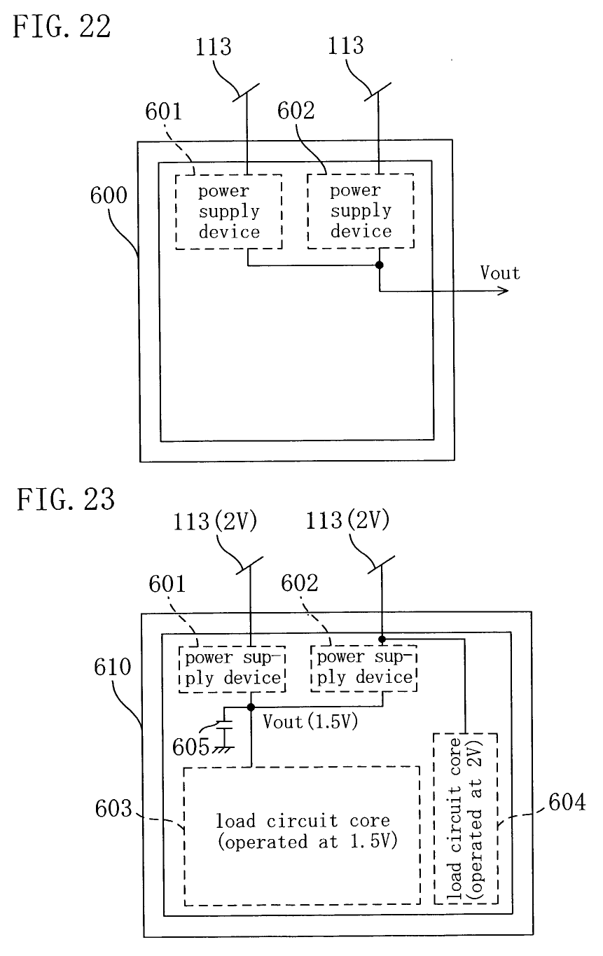

As shown in FIG. 22, by forming one or more power supply devices 601 and 602 on an LSI chip 600, it is possible to configure a power supply LSI that has an improved response characteristic and can supply power without causing a voltage drop in the output voltage Vout according to load current fluctuations.

As shown in FIG. 23, in addition to the power supply devices 601 and 602, it is possible to form, on the same LSI chip 610, a load circuit core 603 that is a load circuit driven by these power supply devices and a load circuit core 604 that is driven by another voltage. Furthermore, with the use of the power supply devices 601 and 602 having good response characteristics as described above, the capacitance required for the capacitor 605 that is a power supply capacitance of the load circuit can be made small. Therefore, the power supply devices can be easily integrated inside the LSI chip 610 unlike conventional examples in which they are externally connected thereto. Hence, it is made possible to reduce the fabrication cost and the size of the apparatus that uses such an LSI chip 610.

It should be noted that, although in the above-described example, the gate voltage (reference voltage Vref2) of the output transistor 125 during the second operation mode is set to be substantially the same voltage as the gate voltage during the first operation mode, the embodiment is not limited thereto. If the reference voltage Vref2 is set according to the following expression:

|V1−Vref2|<|Voff−V1|

where V1 is the gate voltage during the first operation mode and Voff is a power supply voltage (H level) or a ground voltage (L level) at which the output transistor 125 is completely in an OFF state, the rise time of the output voltage Vout can be shortened than in the case where the gate voltage is set to be Voff. In addition, when the reference voltage Vref2 is set according to the following expression:

|V1−Vref2|<|V2−V1|

where V2 is the gate voltage corresponding to the load current flowing during the second operation mode, the rise time of the output voltage Vout can be shortened than in the case where the gate voltage is set to be V2. In addition, when the gate voltage becomes a high impedance and an indefinite voltage, the rise time accordingly becomes indefinite. With the above-described configuration, however, the rise time can be managed at a certain time by setting the gate voltage at a predetermined voltage.

In these cases, as described above, when the gate voltage of the output transistor 125 is closer to the gate voltage during the first operation mode, the rise time of the output voltage Vout is shorter. In practice, the specific setting of the reference voltage Vref2 may be carried out as follows. The amount of fluctuation of the power supply voltage in the case where the load current fluctuates also depends on the amount of fluctuation of the load current and the capacitance of the capacitor 102. For this reason, the reference voltage Vref2 can be set so that the amount of fluctuation of the power supply voltage is smaller than the amount of fluctuation of the power supply voltage that can be permitted in the apparatus to which power is supplied. This means, conversely, that when the reference voltage Vref2 is closer to the voltage V1, the capacitance of the capacitor 102 can be made smaller, and as a consequence, the integration of the capacitor 102 in an LSI and a reduction of the area in the LSI occupied by the capacitor 102 can be easily achieved.

The setting of the reference voltage and its advantageous effects can be also applied to, for example, the reference voltage Vref3 that is applied to the terminal 223a of the capacitor 223, which has been explained in Embodiment 2 above.

In addition, the constituting elements that have been described in the foregoing embodiments may be combined together as necessary. Specifically, for example, the configurations described in Embodiment 3 (such as shown in FIG. 11) in which the current paths that have little or no effect on the response characteristic are cut off may be applied to the power supply device of Embodiment 2 (FIG. 7).

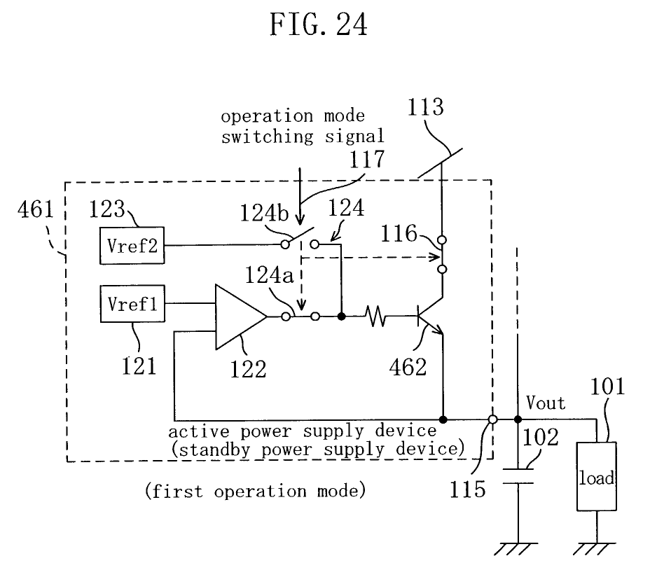

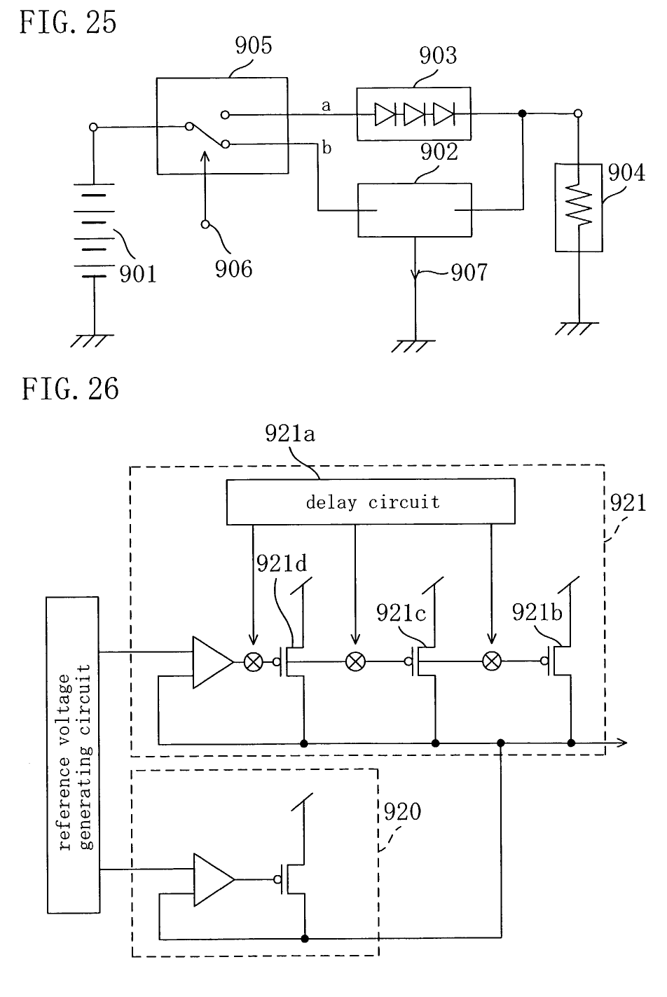

Further, in the above-described example, the output transistor 125 is described as a p-type MOS transistor, but the present invention is not limited thereto and can be applied to such a case of a power supply device 461 shown in FIG. 24, which uses a bipolar-type output transistor 462.

As has been described above, the present invention achieves a power supply device in which the output voltage can rise fast, an output voltage drop can be avoided or reduced at the switching between current supply states or the like, a high current efficiency can be achieved over a wide range of load current without causing a considerable increase in the quiescent current consumption in the power supply device itself, and moreover the device can be easily integrated into a single chip.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A power supply device comprising:
a controlling means for controlling an output voltage to a predetermined voltage during a first operation mode for supplying power;
a cut-off means for cutting off the output voltage during a second operation mode for halting the power supply;
a control state-maintaining means for maintaining a state of at least a portion of the controlling means to be in a standby state during the second operation mode, the standby state corresponding to a state of the portion of the controlling means during the first operation mode.

2. The power supply device according to claim 1, wherein the standby state is a state that is closer to the state during the first operation mode than to the state during the second operation mode.

3. The power supply device according to claim 1, wherein the standby state is a state such that the amount of fluctuation of the output voltage is less than a predetermined amount when the operation mode switches from the second operation mode to the first operation mode.

4. The power supply device according to claim 1, wherein:
the controlling means comprises an output transistor that generates the output voltage according to a voltage of a control terminal; and
the control state-maintaining means is configured so that a voltage of the control terminal is maintained at a predetermined voltage.

5. The power supply device according to claim 1, wherein:
the controlling means comprises an output transistor that generates the output voltage according to a current of a control terminal; and
the control state-maintaining means is configured so that the current of the control terminal is maintained at a predetermined current.

6. The power supply device according to claim 1, wherein:
the controlling means comprises a capacitor element that stores electric charge; and
the control state-maintaining means is configured so that voltages at both ends of the capacitor element is maintained at a predetermined voltage.

7. The power supply device according to claim 1, further comprising a current consumption-reducing means for reducing the current consumption of a portion of the controlling means that does not affect the operation of the control state-maintaining means during the second operation mode.

8. The power supply device according to claim 7, wherein the current consumption-reducing means is configured to cut off a current supply to a portion of the controlling means that does not affect the operation of the control state-maintaining means.

9. The power supply device according to claim 7, wherein the portion of the controlling means that does not affect the operation of the control state-maintaining means includes a feedback circuit to which the output voltage is fed back, the feedback circuit generating a control signal for controlling the output voltage.

10. The power supply device according to claim 1, wherein the current supply to the controlling means and the control state-maintaining means is cut off during a third operation mode.

11. The power supply device according to claim 1, wherein:
the controlling means comprises an operational amplifier; and
the power supply device further comprises a bias current controlling means for controlling a bias current in the operational amplifier.

12. The power supply device according to claim 11, wherein the bias current is controlled according to the output current of the power supply device.

13. The power supply device according to claim 12, wherein the bias current is controlled such that the larger the output current of the power supply device is, the larger the bias current.

14. The power supply device according to claim 1, wherein the state corresponding to the first operation mode is configured to be variable in a plurality of kinds of states.

15. The power supply device according to claim 14, wherein the plurality of kinds of states are set according to the magnitude of a load current during the first operation mode that is after the second operation mode.

16. A power supply device comprising:
a plurality of unit power supply devices supplying electric power to a given node of an apparatus to which power is to be supplied;
wherein at least one of the plurality of unit power supply devices is the power supply device according to claim 1 that is a power supply device capable of maintaining a standby state.

17. A power supply device comprising:
a plurality of unit power supply devices supplying electric power to a given node of an apparatus to which power is to be supplied;
wherein at least one of the plurality of unit power supply devices is the power supply device according to claim 7 that is a power supply device capable of maintaining a standby state.

18. A power supply device comprising:
a plurality of unit power supply devices supplying electric power to a given node of an apparatus to which power is to be supplied;
wherein at least one of the plurality of unit power supply devices is the power supply device according to claim 11 that is a power supply device capable of maintaining a standby state.

19. The power supply device according to claim 16, wherein the power supply device capable of maintaining a standby state is switched between the second operation mode and the first operation mode according to a load current of the apparatus to which power is to be supplied.

20. The power supply device according to claim 19, wherein the power is supplied by a combination of one or more of the unit power supply devices that satisfies a current supply capability according to the load current of the apparatus to which power is supplied and minimizes the power consumption of the power supply device.

21. A power supply device comprising:
a plurality of unit power supply devices supplying electric power to a given node of an apparatus to which power is to be supplied;
wherein at least two or more of the plurality of unit power supply devices are the power supply device according to claim 1; and
each of the two or more of the plurality of unit power supply devices has a different state of at least a portion of the controlling means that is maintained by the control state-maintaining means from one another.

22. The power supply device according to claim 21, wherein, when the combination of one or more of the unit power supply devices that supplies power is changed according to a fluctuation of a load current of the apparatus to which power is supplied, the combination is changed into a combination such that a variation of an output voltage is minimized.

23. The power supply device according to claim 16, wherein the power supply device is formed in a single-chip semiconductor integrated circuit.

24. The power supply device according to claim 1, wherein the power supply device is formed in the same semiconductor integrated circuit as a semiconductor integrated circuit of an apparatus to which power is supplied.

25. A power supply device comprising:
a controlling means for controlling an output voltage for supplying electric power at a predetermined voltage, the controlling means including an operational amplifier; and
a bias current controlling means for controlling a bias current in the operational amplifier.

26. The power supply device according to claim 25, wherein the bias current is controlled according to an output current of the power supply device.

27. The power supply device according to claim 26, wherein the bias current is controlled so that the greater the output current of the power supply device is, the greater the bias current is.
